(19) United States
(12) Patent Application Publication
(10) Pub. No.: US 2024/0221347 A1
(43) Pub. Date: Jul. 4, 2024

(54) METHOD OF OPERATING DEVICE FOR EXTRACTING STYLE-BASED SKETCH AND METHOD OF TRAINING NEURAL NETWORK THEREFOR

(71) Applicant: Korea Advanced Institute of Science and Technology, Daejeon (KR)

(72) Inventors: Junyong NOH, Daejeon (KR); Chang Wook SEO, Daejeon (KR); Amirsaman ASHTARI, Daejeon (KR); Sihun CHA, Daejeon (KR); Cholmin KANG, Daejeon (KR)

(21) Appl. No.: 18/398,777

(22) Filed: Dec. 28, 2023

(30) Foreign Application Priority Data
Dec. 30, 2022 (KR) 10-2022-0190911

(51) Int. Cl. G06V 10/44; G06V 10/32; G06V 10/77; G06V 10/774; G06V 10/776; G06V 10/82

(52) U.S. Cl. CPC G06V 10/44; G06V 10/32; G06V 10/7715; G06V 10/774; G06V 10/776; G06V 10/82

(57) ABSTRACT

Provided is a method of operating a device for extracting a style-based sketch and a method of training a neural network. Through a neural network for extracting a style-based sketch, a sketch obtained by imitating a style may be extracted by precisely detecting lines showing sketches from the color image and the reference image.

### CROSS-REFERENCE TO RELATED APPLICATION

This application claims the benefit of Korean Patent Application No. 10-2022-0190911 filed on Dec. 30, 2022, in the Korean Intellectual Property Office, the entire disclosure of which is incorporated herein by reference for all purposes.

### BACKGROUND

### Field of the Invention

One or more embodiments relate to a method of operating a device for extracting a style-based sketch and a method of training a neural network therefor.

### Description of the Related Art

Authentic sketches drawn by artists have various sketch styles to add visual interest and contribute feeling to the sketch.

Models of the related art for extracting a sketch from an image only extract a general sketch line and fail to apply a style to a sketch. A style conversion model of the related art is designed to extract a texture from a source image, and thus it may not apply a style to a sketch line.

Furthermore, a sketch extraction method of the related art generates a sketch in a fixed style that is different from an authentic sketch, and therefore, it is difficult to obtain excellent performance when auto-colorization is applied to the generated sketch.

### SUMMARY

According to an aspect, there is provided a method of operating a device for extracting a style-based sketch, the method including inputting a color image for extracting a sketch by a first attention-based convolutional layer, inputting a reference image including a style of the sketch by a second attention-based convolutional layer, inputting a sum of attention information output from each of the first attention-based convolutional layer and the second attention-based convolutional layer by a convolutional layer for generating the style-based sketch, inputting a sum of outputs of the first attention-based convolutional layer and the second attention-based convolutional layer by a third attention-based convolutional layer for normalization of the style-based sketch, and extracting a sketch image corresponding to the color image by inputting a sum of outputs of the convolutional layer for generating the style-based sketch and the third attention-based convolutional layer to a decoder.

The third attention-based convolutional layer may be configured to be trained using a loss function of a space between a sketch image of the color image based on the style and a sketch output from the decoder.

The inputting of the reference image including the style of the sketch by the second attention-based convolutional layer may include inputting a reverse image or a rotated image of the reference image.

Based on a pair of a training color image and a sketch image of the training color image based on the style, at least one of the first attention-based convolutional layer, the second attention-based convolutional layer, or the third attention-based convolutional layer may be trained.

The extracting of the sketch image may include outputting, as an image, information indicating that a sketch of the color image based on a style of the reference image is extracted.

According to another aspect, there is provided a method of training a neural network for extracting a style-based sketch, the method including inputting a training color image and a reference sketch image of the training color image to the neural network, extracting a sketch image in a style of the reference sketch image of the training color image from the neural network, calculating a loss function between the reference sketch image and the sketch image, and training at least one of a first attention-based convolutional layer, a second attention-based convolutional layer, or a third attention-based convolutional layer constituting the neural network using the loss function.

The inputting of the training color image and the reference sketch image of the training color image to the neural network may include inputting the reference sketch image that is reversed or rotated to the neural network.

The calculating of the loss function between the reference sketch image and the sketch image may include calculating the loss function between a space of the reference sketch image and a space of the sketch image. The training of the at least one attention-based convolutional layer may include, by the third attention-based convolutional layer for normalizing the space of the sketch image, training at least one of the first attention-based convolutional layer, the second attention-based convolutional layer, or the third attention-based convolutional layer by inputting the calculated loss function between the spaces.

The calculating of the loss function between the reference sketch image and the sketch image may include calculating a difference between pieces of feature information extracted from the reference sketch image and the sketch image. The training of the at least one attention-based convolutional layer may include training at least one of the first attention-based convolutional layer, the second attention-based convolutional layer, or the third attention-based convolutional layer in reference to the calculated difference between the pieces of the feature information.

The calculating of the loss function between the reference sketch image and the sketch image may include obtaining an adversarial loss output from a discriminator of the neural network. The training of the at least one attention-based convolutional layer may include training at least one of the first attention-based convolutional layer, the second attention-based convolutional layer, or the third attention-based convolutional layer in further reference to the adversarial loss.

According to another aspect, there is provided a device for extracting a style-based sketch, the device including at least one processor, a memory, and at least one program stored in the memory and configured to be executed by the at least one processor. The program may be configured to execute inputting a color image for extracting a sketch by a first attention-based convolutional layer, inputting a reference image including a style of the sketch by a second attention-based convolutional layer, inputting a sum of attention information output from each of the first attention-based convolutional layer and the second attention-based convolutional layer by a convolutional layer for generating the style-based sketch, inputting a sum of outputs of the first attention-based convolutional layer and the second attention-based convolutional layer by a third attention-based convolutional layer for normalization of the style-based sketch, and extracting a sketch image corresponding to the color image by inputting a sum of outputs of the convolutional layer for generating the style-based sketch and the third attention-based convolutional layer to a decoder.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of a sketch extracted through a trained neural network in an embodiment;

FIG. 2 is a flowchart illustrating a method of operating a device for extracting a style-based sketch in an embodiment;

FIG. 3 is a flowchart illustrating a method of training a neural network for extracting a style-based sketch in an embodiment;

FIG. 4 is a diagram illustrating a structure of a neural network to be trained in an embodiment; and

FIG. 5 is a diagram illustrating a configuration of a device for extracting a style-based sketch through a trained neural network in an embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, the terms first, second, A, B, (a), and (b) may be used to describe constituent elements of the embodiments. These terms are used only for the purpose of discriminating one component from another component, and the nature, the sequences, or the orders of the components are not limited by the terms. When it is mentioned that one component is “connected” or “accessed” to another component, it may be understood that the one component is directly connected or accessed to another component or that still other component is interposed between the two components.

The same name may be used to describe an element included in the embodiments described above and an element having a common function. Unless otherwise mentioned, the descriptions on the embodiments may be applicable to the following embodiments and thus, duplicated descriptions will be omitted for conciseness.

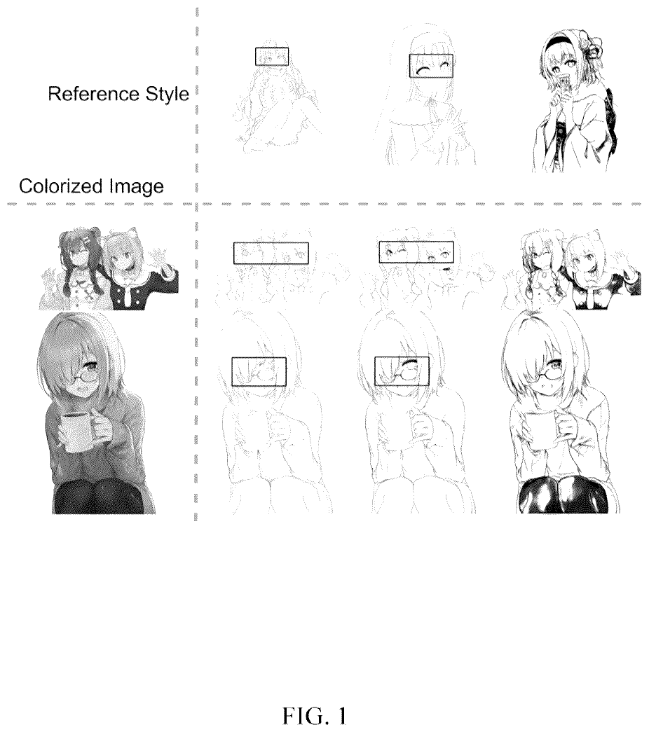

FIG. 1 illustrates an example of a sketch extracted through a trained neural network in an embodiment.

When a color image and a reference image of a sketch in a desired style are input, a neural network trained through an embodiment may extract a sketch in the style of the reference image from the color image.

Through a neural network for extracting a style-based sketch, a sketch obtained by imitating a style may be extracted by precisely detecting lines showing sketches from the color image and the reference image.

An embodiment may propose a method of extracting a style-based sketch through a neural network trained based on a generative adversarial network (GAN). The neural network may be trained so that a sketch of the color image is extracted to be closest to various reference sketches in styles. The neural network may include independent attention-based convolutional layers, and the corresponding layers may be trained to separately extract a sketch of each of the color image and the reference image and realize visual correspondence between the two images.

For the training of the neural network, pairs of various color images and sketches of color images may be respectively input to different attention-based convolutional layers of the neural network, and the neural network may be trained so that the style-based sketch is extracted from the color images. Hereinafter, a method of outputting a style-based sketch through a structure of a trained neural network and a method of training the corresponding neural network will be described in detail.

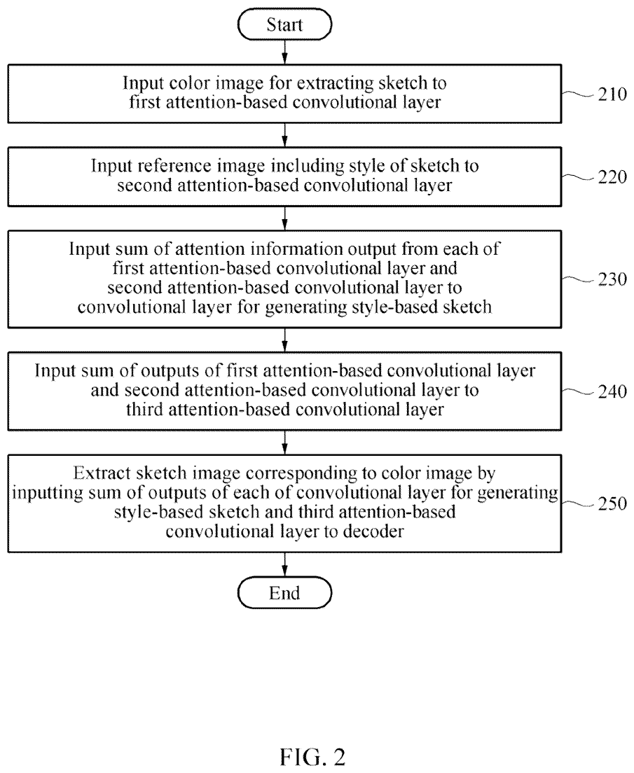

FIG. 2 is a flowchart illustrating a method of operating a device for extracting a style-based sketch in an embodiment.

The device may include a neural network trained through an embodiment, and output a style-based sketch image of a color image according to a reference image including a sketch in a desired style in response to an input color image. The reference image may include a reverse or rotated image of an original image.

The device may receive a color image for obtaining a sketch and a reference image including a sketch in a desired style from a user.

In operation 210, the device inputs a color image for extracting a sketch to a first attention-based convolutional layer.

In operation 220, the device inputs a reference image including a style of a sketch to a second attention-based convolutional layer.

The device may input each of the color image and the reference image to an independent attention-based convolutional layer. In order to input an image to an attention-based convolutional layer, the device may include an encoder on an input end of each layer, and feature information extracted from the color image and the reference image may be input to each attention-based convolutional layer through the encoder.

In operation 230, the device inputs a sum of attention information output from each of the first attention-based convolutional layer and the second attention-based convolutional layer to a convolutional layer for generating a style-based sketch.

The neural network may include a block for concatenating attention information output from each of the first attention-based convolutional layer and the second attention-based convolutional layer.

In operation 240, the device may input a result of concatenating the attention information output from each of the first attention-based convolutional layer and the second attention-based convolutional layer to a third attention-based convolutional layer for normalization of the style-based sketch.

The result of concatenating the attention information output from each of the first attention-based convolutional layer and the second attention-based convolutional layer may be respectively input in parallel to a residual neural network (ResNet)-based convolutional layer and the third attention-based convolutional layer.

The third attention-based convolutional layer is for normalization and may obtain information for ensuring a blank of a sketch image output from the device. For example, the third attention-based convolutional layer may be trained with a difference between a blank included in the reference image and a blank of the output sketch image as a loss function so that the sketch image is output without any noise, and the sketch of the sketch image may be normalized through the trained third attention-based convolutional layer.

The ResNet-based convolutional layer for generating the style-based sketch may output feature information for generating a sketch of a color image based on the style of the reference image.

In operation 250, the device may extract a sketch image corresponding to the color image by inputting a sum of outputs of each of the convolutional layer for generating the style-based sketch and the third attention-based convolutional layer to a decoder.

A result output from two layers of the ResNet-based convolutional layer and the third attention-based convolutional layer may be concatenated again and input to the decoder.

An image output from the decoder may correspond to a sketch image of the input color image, and the sketch image may correspond to a sketch in a style of the input reference image.

The neural network may be trained based on a pair of a training color image and a sketch image based on a style of the training color image, and at least one of the first to third attention-based convolutional network or the ResNet-based convolutional layer included in the neural network may be trained.

Hereinafter, a method of training the neural network will be described in detail.

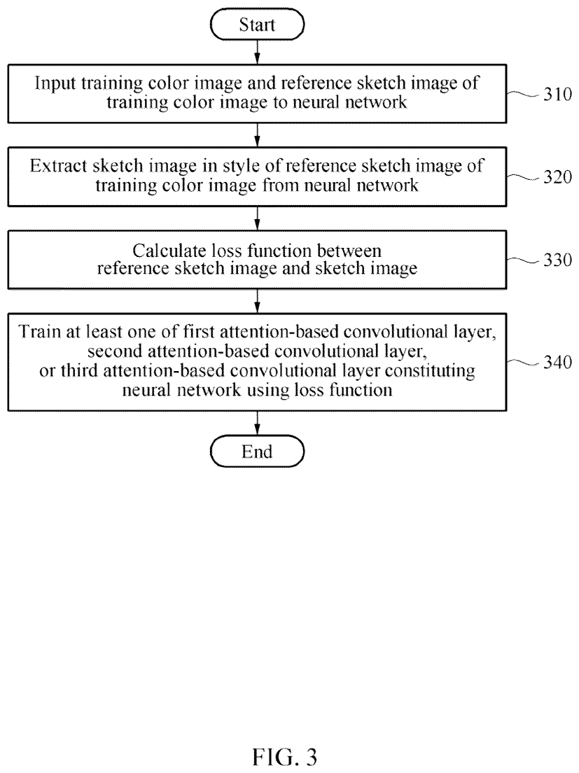

FIG. 3 is a flowchart illustrating a method of training a neural network for extracting a style-based sketch in an embodiment.

In an embodiment, the training may be performed by a device, and the device may not be the same as the device described above with reference to FIG. 2.

As described above with reference to FIG. 2, the neural network may include a plurality of attention-based convolutional layers.

In operation 310, the device inputs a training color image and a reference sketch image of the training color image to the neural network.

The reference sketch image corresponds to a sketch image of the training color image having a style. When the reference sketch image is input to the neural network without being deformed, the training of the neural network may not be performed and the reference sketch image may be output as it is. Accordingly, for the reference sketch image, a deformed image such as a reverse or rotated image based on the training color image may be input to the neural network. The reference sketch image may be deformed while maintaining the style. The reference sketch image corresponds to a style of a ground truth trained by the neural network.

Each of the training color image and the reference sketch image may be input to an independent encoder, and may be input to an attention-based convolutional layer connected to the encoder.

In operation 320, the device extracts a sketch image of the training color image in a style of the reference sketch image from the neural network.

An image to be output may correspond to the sketch image of the input training color image, and the corresponding sketch image may be extracted based on the style of the input reference sketch image.

In operation 330, the device calculates a loss function between the reference sketch image and the sketch image.

The neural network may be adaptively trained based on the loss function, and may be trained using three loss functions in an embodiment.

A first loss function is obtained by calculating a visual feature difference between the reference sketch image and the sketch image. A second loss function is obtained for normalization between a blank of the reference sketch image and a blank of the sketch image. A third loss function is an adversarial loss output from a discriminator connected to a decoder end of the neural network.

In operation 340, at least one of a first attention-based convolutional layer, a second attention-based convolutional layer, and a third attention-based convolutional layer constituting the neural network may be trained using the loss functions.

Each of the attention-based convolutional layers of the neural network may be independently trained to extract attention information of a sketch line and style from the training color image and the reference sketch image. When the reference sketch image is given, the attention-based convolutional layers may be adaptively trained such that information on a space that should be emphasized or attenuated is output from the reference sketch image. For this, the loss functions described above may be defined.

The device may input the first loss function to train at least one of the attention-based convolutional layers constituting the neural network so that a sketch image close to the reference sketch image is output from the training color image and the corresponding loss function is close to 0.

The second loss function may be input to the third attention-based convolutional layer for normalization. At least one of the attention-based convolutional layers may be trained so that a space of the sketch image by the output of the third attention-based convolutional layer corresponds to the reference sketch image.

For the training of the neural network, the discriminator may be connected to the decoder end, and at least one of the attention-based convolutional layers may be trained so that the sketch image becomes closer to the reference sketch image corresponding to an original image by using an output of the discriminator as the loss function.

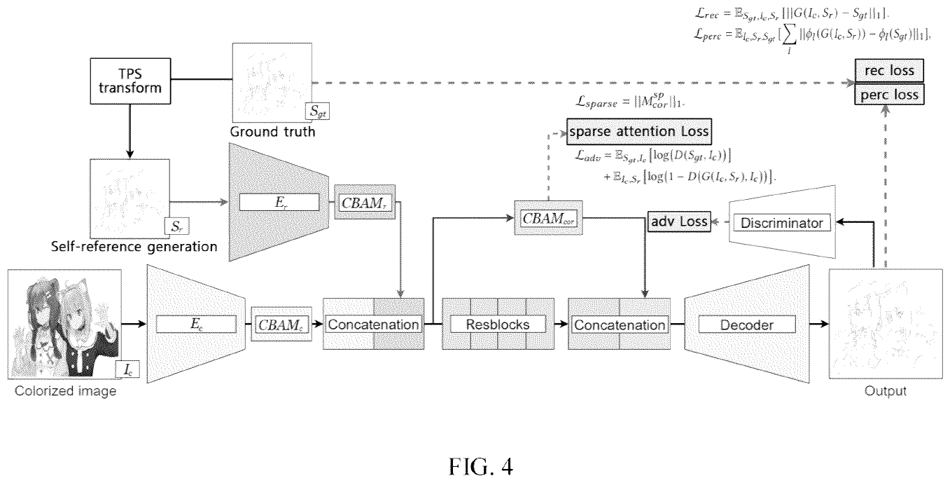

FIG. 4 is a diagram illustrating a structure of a neural network to be trained in an embodiment.

A neural network model according to an embodiment may be trained so that a sketch is extracted from the training color image in visually similar way to the input reference sketch image. As shown in FIG. 4, inputs for the neural network model may be a training color image Ic and a reference sketch image Sr, and an output may be a sketch image of the training color image output in a style that is most similar to the given reference sketch image. The sketch image corresponds to an output having a spatially different layout of a style similar to a ground truth image Sgt of the reference sketch image.

First, to generate the reference sketch image Sr, the ground truth image Sgt may be transformed. For this, a transformation technology such as thin plate splines (TPS) transformation or random flips may be applied.

The color image and the sketch image may be input to two independent encoders Ec(Ic) and Er(Sr) and then may be transmitted to two independent convolutional block attention module (CBAM) and the attention-based convolutional layer which are CBAMc(Ec(Ic)) and CBAMr(Er(Sr)).

After that, pieces of encoded attention information may be concatenated and pass through a ResNet-based convolutional block (Resblocks) and CBAMcor in parallel. Here, the CBAMcor may be trained with a method of encoding a spatial correspondence relationship between styles of the color image and the reference sketch image. An output of the Resblocks and CBAMcor may be connected to provide the output to the decoder, and a sketch similar to the style of the reference sketch image may be finally output.

The discriminator is to derive an adversarial loss and discriminate the extracted sketch image from a real image, and may be used when training the neural network.

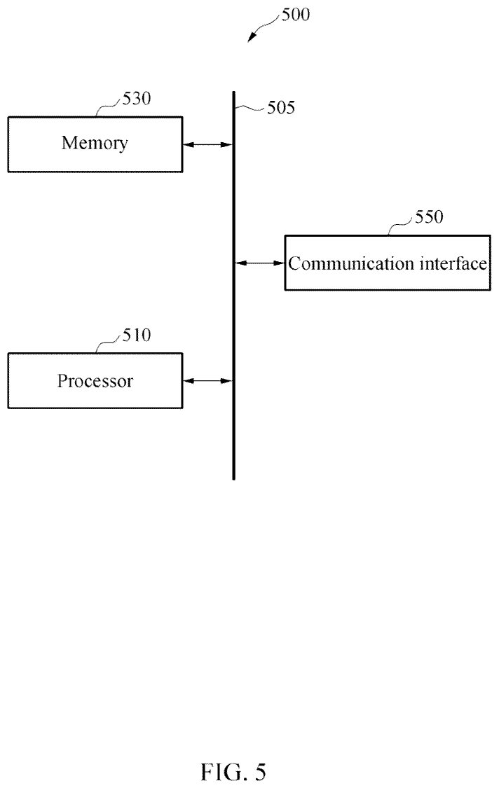

FIG. 5 is a diagram illustrating a configuration of a device for extracting a style-based sketch through a trained neural network in an embodiment.

A device 500 may include a memory 530, at least one processor 510, and a communication interface 550, and may include at least one program stored in the memory and configured to be executed by the at least one processor.

The processor 510 according to an embodiment may execute inputting a color image for extracting a sketch by a first attention-based convolutional layer, inputting a reference image including a style of the sketch by a second attention-based convolutional layer, inputting a sum of attention information output from each of the first attention-based convolutional layer and the second attention-based convolutional layer by a convolutional layer for generating the style-based sketch, inputting a sum of outputs of the first attention-based convolutional layer and the second attention-based convolutional layer by a third attention-based convolutional layer for normalization of the style-based sketch, and extracting a sketch image corresponding to the color image by inputting a sum of outputs of the convolutional layer for generating the style-based sketch and the third attention-based convolutional layer to a decoder.

The memory 530 may be a volatile memory or a non-volatile memory, and the processor 510 may execute a program and control the device 500. Program code executed by the processor 510 may be stored in the memory 530. The device 500 may be connected to an external device (e.g., a personal computer or a network) through an input and output device (not shown) to exchange data. The device 500 may be mounted on various computing devices and/or systems, such as a smartphone, tablet computer, laptop computer, desktop computer, television, wearable device, security system, and smart home system.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

As described above, although the embodiments have been described with reference to the limited drawings, a person skilled in the art may apply various technical modifications and variations based thereon.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method of operating a device for extracting a style-based sketch, the method comprising:
inputting a color image for extracting a sketch by a first attention-based convolutional layer;
inputting a reference image comprising a style of the sketch by a second attention-based convolutional layer;
inputting a sum of attention information output from each of the first attention-based convolutional layer and the second attention-based convolutional layer by a convolutional layer for generating the style-based sketch;
inputting a sum of outputs of the first attention-based convolutional layer and the second attention-based convolutional layer by a third attention-based convolutional layer for normalization of the style-based sketch; and
extracting a sketch image corresponding to the color image by inputting a sum of outputs of the convolutional layer for generating the style-based sketch and the third attention-based convolutional layer to a decoder.

2. The method of claim 1, wherein the third attention-based convolutional layer is configured to be trained using a loss function of a blank between a sketch image of the color image based on the style and a sketch output from the decoder.

3. The method of claim 1, wherein the inputting of the reference image comprising the style of the sketch by the second attention-based convolutional layer comprises inputting a reverse image or a rotated image of the reference image.

4. The method of claim 1, wherein, based on a pair of a training color image and a sketch image of the training color image based on the style, at least one of the first attention-based convolutional layer, the second attention-based convolutional layer, or the third attention-based convolutional layer is trained.

5. The method of claim 1, wherein the extracting of the sketch image comprises outputting, as an image, information indicating that a sketch of the color image based on a style of the reference image is extracted.

6. A method of training a neural network for extracting a style-based sketch, the method comprising:
inputting a training color image and a reference sketch image of the training color image to the neural network;
extracting a sketch image in a style of the reference sketch image of the training color image from the neural network;
calculating a loss function between the reference sketch image and the sketch image; and
training at least one of a first attention-based convolutional layer, a second attention-based convolutional layer, or a third attention-based convolutional layer constituting the neural network using the loss function.

7. The method of claim 6, wherein the inputting of the training color image and the reference sketch image of the training color image to the neural network comprises inputting the reference sketch image that is reversed or rotated to the neural network.

8. The method of claim 6, wherein
the calculating of the loss function between the reference sketch image and the sketch image comprises calculating the loss function between a blank of the reference sketch image and a blank of the sketch image, and
the training of the at least one attention-based convolutional layer comprises, by the third attention-based convolutional layer for normalizing the blank of the sketch image, training at least one of the first attention-based convolutional layer, the second attention-based convolutional layer, or the third attention-based convolutional layer by inputting the calculated loss function between the blanks.

9. The method of claim 6, wherein
the calculating of the loss function between the reference sketch image and the sketch image comprises calculating a difference between pieces of feature information extracted from the reference sketch image and the sketch image, and
the training of the at least one attention-based convolutional layer comprises training at least one of the first attention-based convolutional layer, the second attention-based convolutional layer, or the third attention-based convolutional layer in reference to the calculated difference between the pieces of the feature information.

10. The method of claim 6, wherein
the calculating of the loss function between the reference sketch image and the sketch image comprises obtaining an adversarial loss output from a discriminator of the neural network, and
the training of the at least one attention-based convolutional layer comprises training at least one of the first attention-based convolutional layer, the second attention-based convolutional layer, or the third attention-based convolutional layer in further reference to the adversarial loss.

11. A non-transitory computer-readable storage medium storing instructions that, when executed by a processor, cause the processor to perform the method of claim 1.

12. A device for extracting a style-based sketch, the device comprising:
at least one processor;
a memory; and
at least one program stored in the memory and configured to be executed by the at least one processor,
wherein the program is configured to execute:
inputting a color image for extracting a sketch by a first attention-based convolutional layer;
inputting a reference image comprising a style of the sketch by a second attention-based convolutional layer;
inputting a sum of attention information output from each of the first attention-based convolutional layer and the second attention-based convolutional layer by a convolutional layer for generating the style-based sketch;
inputting a sum of outputs of the first attention-based convolutional layer and the second attention-based convolutional layer by a third attention-based convolutional layer for normalization of the style-based sketch; and
extracting a sketch image corresponding to the color image by inputting a sum of outputs of the convolutional layer for generating the style-based sketch and the third attention-based convolutional layer to a decoder.

13. The device of claim 12, wherein the third attention-based convolutional layer is configured to be trained using a loss function of a blank between a sketch image of the color image based on the style and a sketch output from the decoder.

14. The device of claim 12, wherein the inputting the reference image comprising the style of the sketch by the second attention-based convolutional layer comprises inputting a reverse image or a rotated image of the reference image.

15. The device of claim 12, wherein, based on a pair of a training color image and a sketch image of the training color image based on the style, at least one of the first attention-based convolutional layer, the second attention-based convolutional layer, or the third attention-based convolutional layer is trained.

16. The device of claim 12, wherein the extracting of the sketch image comprises outputting, as an image, information indicating that a sketch of the color image based on a style of the reference image is extracted.
